(19) United States
(12) Patent Application Publication
(10) Pub. No.: US 2003/0069803 A1
(43) Pub. Date: Apr. 10, 2003

(54) Method of displaying content

(75) Inventor: Mike Pollitt, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Blast Media Pty Ltd, Surry Hills (AU)

(21) Appl. No.: 09/991,390

(22) Filed: Nov. 20, 2001

(30) Foreign Application Priority Data
Sep. 28, 2001 (AU) PR7975

(51) Int. Cl. G06F 17/60

(52) U.S. Cl. 705/26; 705/27

(57) ABSTRACT

The present invention provides a method of obtaining content from a remote store using an end station, the end station and the store being coupled to a processing system, the store storing a number of content instances and, content details, the content details providing predetermined information relating to each content instance, the method including:

a) Generating a content request using the end station;

b) Transferring the content request to the processing system;

c) Causing the processing system to select one or more content instances in accordance with the received content request;

d) Transferring the content details of the selected content instances to the end station;

e) Determining one or more of the content instances to be received;

f) Generating a content selection using the end station, the content selection indicating one or more of the selected content instances; and,

g) Transferring the content selection to the processing system;

h) Causing the processing system to transfer the content instances to the end station in accordance with the received selection request.

### BACKGROUND OF THE INVENTION

The present invention relates to a method and apparatus for displaying content and in particular, content such as images or video sequences.

### DESCRIPTION OF THE PRIOR ART

In the past storage and access to high volume data, including digital media, such as audio and/or video information, was typically achieved by providing a database in the location from which access was required. Thus, for example, if companies needed to store records and data, it would be typical to use a database located at the company's offices, and coupled directly to the companies Local Area Network (LAN).

In recent years, the introduction of global networks, such as the Internet has allowed data from a number of different locations to be stored centrally. However, this in turn leads to an increase in the amount of data that needs to be stored in a given location, which can cause further problems, such as problems in organizing the data so that it easily accessible, as well as storing the volume of data safely.

An example of a system that aims to address some of these problems is disclosed in U.S. Pat. No. 6,181,336. This document describes a system that allows multimedia type data such as films, animation, video games, and the like to be stored and retrieved. This is achieved using tailored hardware and software that provides a number of management systems to allow data to be stored in and retrieved from database repositories.

However, the functionality provided by the software is limited. In particular the manner in which the data is stored and retrieved requires a large amount of manual input from the user. Furthermore, the database repositories are still vulnerable to catastrophic failure, which could lead to the loss of all data. In addition to this, the system does not provide a rights management system that prevents unauthorized duplication and/or distribution of the data. This is particularly important as it allows digital media to be distributed in a controlled manner, such as on a pay per view basis.

### BRIEF SUMMARY OF THE INVENTION

In a first broad form the present invention provides a method of obtaining content from a remote store using an end station, the end station and the store being coupled to a processing system, the store storing a number of content instances and, content details, the content details providing predetermined information relating to each content instance, the method including:

a) Generating a content request using the end station;

b) Transferring the content request to the processing system;

c) Causing the processing system to select one or more content instances in accordance with the received content request;

d) Transferring the content details of the selected content instances to the end station;

e) Determining one or more of the content instances to be received;

f) Generating a content selection using the end station, the content selection indicating one or more of the selected content instances; and,

g) Transferring the content selection to the processing system;

h) Causing the processing system to transfer the content instances to the end station in accordance with the received selection request.

Typically the method of transferring the content instances to the end station in response to the received selection includes:

a) Determining a cost for providing the content;

b) Providing payment details in response to the determined cost;

c) Transferring the payment details from the end station to the processing system;

d) Causing the processing system to determine if the payment can be collected; and,

e) Transferring the content instances to the end station in response to a successful determination.

The method of determining a cost generally includes:

a) Indicating the intended use of the content; and,

b) Determining the cost based on the intended use of the content.

The method further usually further includes:

a) Transferring the indication of the intended use from the end station to the processing system; and,

b) Causing the processing system to:

i) Access cost data stored in the store; and,

ii) Determine a cost based on the cost data and the intended use of the content.

Typically the method of transferring the content instances to the end station in response to the received selection includes:

a) Indicating the intended use of the content;

b) Transferring an indication of the intended use from the end station to the processing system;

c) Causing the processing system to generate a licensing agreement based on the intended use of the content;

d) Transferring the license to the end station;

e) Determining if the license is acceptable; and,

f) Transferring the content instances to the end station in response to a successful determination.

When the end station is coupled to the processing system via the Internet, the method of transferring the content to the end station includes transferring the content typically includes:

a) Using a FTP (File Transfer Protocol);

b) At a predetermined time; or

c) Via e-mail.

Typically the content request includes one or more keywords, the method including:

a) Causing the processing system to parse the keyword(s) to determine any:

i) Misspellings;

ii) Synonyms;

iii) Semantically non-unique keywords;

b) In response to a successful determination, causing the processing system to generate a query, the query requesting clarification of the respective keyword(s);

c) Providing a response to the query, the response including either:

i) A correctly spelled keyword; or

ii) Additional information to clarify the keyword so that the semantics or the synonym is uniquely identified;

d) Transferring the response to the processing system; and,

e) Causing the processing system to select content in accordance with the received response.

Typically, the content request includes one or more keywords, the content details includes one or more keyword(s) associated with each content instance, the method of selecting content includes causing the processing system to:

a) Compare the received keyword(s) and the content data; and,

b) Select the content in accordance with the results of the comparison.

Typically, the content request includes one or more keywords, the content being classified using a hierarchical classification scheme, and the content details includes one or more category designations representing the categories within which the content is classified, the method of selecting content includes causing the processing system to:

a) Compare the received keyword(s) to each category in the classification;

b) Select one or more categories in accordance with the results of the comparison; and,

c) Select the content from the one or more determined categories.

Typically, the content request includes one or more parameter values, the content details include one or more parameter values associated with each content instance, the method of selecting content includes causing the processing system to:

a) Compare the received parameter value(s) and the content data; and,

b) Select the content in accordance with the results of the comparison.

Typically, the parameter value(s) include a threshold, the method further usually include causing the processing system to:

a) Compare each received parameter value to each parameter value associated with each content instance;

b) Determine the comparison to be successful if the difference between the parameter values is less than the threshold;

c) Select the content associated with each parameter value for each successful comparison.

The content typically includes any of:

a) Images;

b) Video sequences; and,

c) Audio sequences.

Additionally, other forms of content may be stored, such as applications software, video/computer games, company records, multimedia data, or the like.

When the content is an image or a video sequence, the corresponding content details can include at least a proxy image, the proxy image being a low resolution version of the image or of one of the video sequence images, the proxy image being transferred to the end station as part of the content details. Similarly, in the case of audio sequences, a low quality version of the sequence may be stored as a proxy.

The content can also be encrypted in accordance with a predetermined encryption system, to thereby control the access of users to the data. This is preferably a digital rights management encryption system, although any form of encryption could be used.

In a second broad form the invention provides apparatus for obtaining content from a remote store using an end station, the apparatus including a processing system adapted to:

a) Receive a content request from an end station;

b) Select one or more content instances in accordance with the received content request;

c) Transfer the content details of the selected content instances to the end station;

d) Receive an indication of one or more of the content instances to be received;

e) Transfer the content instances to the end station in accordance with the received selection request.

In this case, the apparatus is typically adapted to perform the method of the first broad form of the invention.

In a third broad form the present invention provides a computer program product including computer executable code that, when executed by a suitably programmed processing system, causes the processing system to:

a) Receive a content request from an end station;

b) Select one or more content instances in accordance with the received content request;

c) Transfer the content details of the selected content instances to the end station;

d) Receive an indication of one or more of the content instances to be received;

e) Transfer the content instances to the end station in accordance with the received selection request.

Typically the computer program product is adapted to cause the processor to perform the method of the first broad form of the invention.

In an fourth broad form the present invention provides a method of processing content for subsequent storage in a store, the method including, for each content instance:

a) Defining one or more keywords;

b) Causing a processing system to:

i) Receive the content instance to be stored;

ii) Select one or more categories from a hierarchical classification scheme, in accordance with the selected keyword(s);

iii) Generate content details, including an indication of the selected categories; and,

iv) Store the content instance and the associated content details in the store.

Typically, the method further includes:

a) Causing the processing system to generate an indication of the selected categories; and,

b) Allowing a user modify the selected categories.

The store is preferably a database with the content details forming the meta-data associated with the respective content instance stored in the database.

Typically, the method further includes:

a) Causing the processing system to parse the received keyword(s) to determine any:

i) Misspellings;

ii) Synonyms;

iii) Semantically non-unique keywords;

b) In response to a successful determination, causing the processing system to generate a query, the query requesting clarification of the respective keyword(s);

c) Providing a response to the query, the response including either:

i) A correctly spelled keyword; or

ii) Additional information to clarify the keyword so that the semantics or the synonym is uniquely identified;

d) Transferring the response to the processing system.

The method usually includes:

a) Defining a number of parameters; and,

b) Setting a parameter value for each content instance for selected ones of the parameters, the parameter value(s) being stored in the content details for each respective content instance, the parameter value being searchable to allow content to be located.

The method typically further includes defining a threshold for selected ones of the parameter value(s), the threshold indicating a range of values.

In a fifth broad form the present invention provides apparatus for processing content for subsequent storage in a store, the apparatus including a processing system coupled to a store, the processing system including a processor adapted to:

a) Obtain the content to be stored;

b) Receive one or more keywords;

c) Select one or more categories from a hierarchical a hierarchical classification scheme, in accordance with the selected keyword(s);

d) Generate content details, including an indication of the selected categories; and,

e) Store the content instance and the associated content details in the store.

Typically the apparatus is adapted to perform the method of the fourth broad form of the invention.

In a sixth broad form the present invention provides a computer program product including computer executable code that when executed by a suitably programmed processing system, causes the processing system to:

a) Obtain the content to be stored;

b) Receive one or more keywords;

c) Select one or more categories from a hierarchical a hierarchical classification scheme, in accordance with the selected keywords;

d) Generate content details, including an indication of the selected categories; and,

e) Store the content instance and the associated content details in the store.

Typically the computer program product is further adapted to cause the processing system to perform the method of the fourth broad form of the invention.

Apparatus for providing content to an end station, the apparatus including:

a) A store for storing:

i) A number of content instances; and,

ii) Content details, the content details providing predetermined information relating to each content instance; and,

b) A processing system coupled to the end station, the processing system being adapted to:

i) Receive a request for content from the end station;

ii) Select one or more content instances in accordance with the received content request;

iii) Transfer the content details of the selected content instances to the end station;

iv) Receive a content selection from the end station, the content selection indicating one or more of the selected content instances; and,

v) Transferring the content instances to the end station in response to the received selection request.

Typically, the processing system includes:

a) A first processing system coupled to the end station; and,

b) A second processing system coupled to the first processing system and the store.

Preferably the first and second processing systems are coupled via a TCP/IP link. This may be for example the Internet, although any suitable link, such as an Ethernet LAN maybe used.

The first processing system is usually adapted to:

a) Receive the content request or content selection from the end station;

b) Generate one or more respective marked-up messages in accordance with the received content request or content selection;

c) Transfer the marked-up messages to the second processing system, the second processing system responding to the content request or content selection to provide content details or content instances; and,

d) Transfer the content details or content instances to the end station.

The marked-up messages are preferably generated in accordance with an XML protocol.

The first and second processing system may be positioned at different physical locations.

The first processing system typically forms part of the end station.

Preferably the processing system is adapted to operate in accordance with the method of the first broad form of the invention.

In a seventh broad form the present invention provides a system for providing content to a user, the system including:

a) An end station; and,

b) Apparatus according to the sixth broad form of the invention.

Typically the system includes:

a) At least two second processing systems positioned at different physical locations, each second processing system being associated with a respective store; and,

b) At least one first processing system adapted to communicate with either one of the second processing systems.

Each second processing system may be coupled to the store associated with the other second processing system, such that each second processing system can obtain content from either one of the stores.

When at least one first processing system is provided remotely to the second processing systems, the first processing system may be coupled to the second processing systems via the Internet.

### BRIEF DESCRIPTION OF THE DRAWINGS

An example of the present invention will now be described with reference to the accompanying drawings, in which:

FIG. 1 is a schematic diagram of a system for implementing the present invention;

FIG. 2 is a schematic diagram of one of the processing systems 9 of FIG. 1;

FIG. 3 is a schematic diagram of one of the processing systems 10 of FIG. 1;

FIG. 4 is a schematic diagram of one of the end stations of FIG. 1;

FIG. 5 is a schematic diagram of the functionality of the system of FIG. 1;

FIG. 6 is a flow diagram outlining the operation of the system of FIG. 1 to store content;

FIG. 7 is a flow diagram outlining the operation of the system of FIG. 1 to retrieve content;

FIGS. 8A and 8B are flow diagrams detailing the operation of the system of FIG. 1 to store content; and,

FIGS. 9A, 9B, 9C and 9D are flow diagrams detailing the operation of the system of FIG. 1 to retrieve content.

### DETAILED DESCRIPTION OF THE PREFERRED EMBODIMENTS

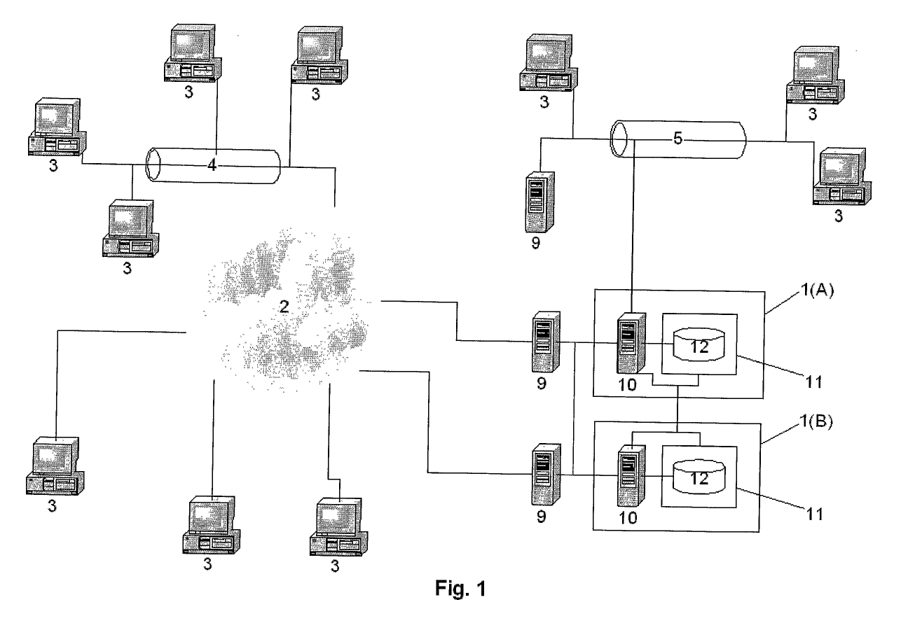

FIG. 1 shows a system that is adapted to store content in a centralized database system for subsequent access by users. In particular, the system is adapted to store high volume data, such as media files and then control access to the media files depending on the nature of the file and the user attempting to access the data.

As shown, in this example, the system includes two base stations 1 (A), 1 (B), each of which is coupled to a number of end stations 3, via communications networks 2, 4, 5 and via processing systems 9.

The communications networks 2, 4, 5 may consist of any suitable communications networks that allow the end stations 3 to connect to the base station 1. Thus for example, the networks could be formed from Local Area Networks (LANs), Wide Area Networks (WANs), or the like, and may be wired or wireless networks.

In this particular example, the communications network 2 is the Internet, which allows the end stations to access the base station 1 from remote locations, which may be distributed world-wide. In addition to this, the communications networks 4, 5 are typically LANs, such as Ethernet LANs. The LAN 4 allows the end stations 3 connected thereto, to access the base station 1 via the Internet 2, whereas the LAN 5 allows direct access to the base station 1(A). Accordingly, the LAN 5 may be located at the same geographical location as the base station 1(A).

As shown, the base station 1 typically includes one or more processing systems 10 coupled to a data store 11, which may be any form of data store, such as a hard-drive, electronic memory, or the like. However, typically the data store includes a combination of storage means, such as hard drives, and a backup system, such as a tape drive. The data store 11 is adapted to store at least one database 12 including the content and associated content details, as well as user data and other information, as will be described in more detail below.

In use, the base station 1 operates to store content such as media files in the database 12, as well as to control access to the stored content by the end stations 3. This is achieved using the processing systems 9, as will be explained in more detail below.

In this example, two identical base stations are provided, each of which is coupled to a respective processing system 9, as shown. Each of the two base stations will be located at different physical locations and will maintain an identical database for the purposes of redundancy. This ensures that even in the event of catastrophic failure of one of the base stations 1(A), 1(B), the other base station 1(B), 1(A) can act as a back up. This form of operation will be described in more detail below. However, it will be appreciated that the functionality of other aspects of the invention may be achieved without the provision of two base stations, which is therefore not essential to all the present invention.

In use, access to the system by the end stations 3 is achieved by accessing web pages generated by either the processing systems 9 or the processing systems 10, depending on the particular implementation.

Accordingly, at least one of the processing systems 9, 10 must be capable of generating web-pages, with the end stations 3 being capable of accessing the web-pages via the Internet.

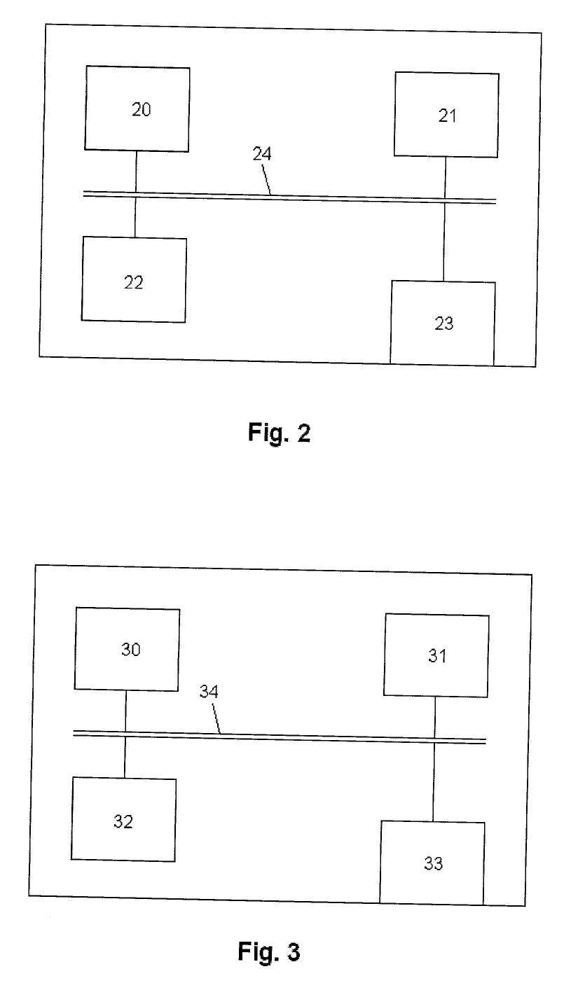

In addition to this, the processing system 9 also operates to receive requests for content from the end stations 3 and translate this into a format suitable for the processing system 10. An example of a suitable processing system is shown in FIG. 2, and this includes a processor 20, a memory 21, an Input/Output (I/O) device 22 and an interface 23, which are coupled together via a bus 24.

It will be appreciated from this that the processing system may be any form of processing device, a personal computer, a lap-top or the like that is executing suitable applications software and that is capable of connecting to the end stations 3 via the communications networks 2, 4, 5. Typically however, in view of the need to provide large amounts of data processing and control, the processing systems 9 are formed from network servers, such as web servers, or the like.

Similarly, each processing system 10 must be capable of receiving requests for content from the processing systems 10, as well as providing access to content stored in the database 12, and allowing for the storage of content. An example of a suitable processing system is shown in FIG. 3, and this includes a processor 30, a memory 31, an I/O device 32, such as a screen and keyboard, and an interface 33, which are coupled together via a bus 34.

Again, the processing systems 10 may be any form of processing device but are typically network servers, such as web servers, or the like.

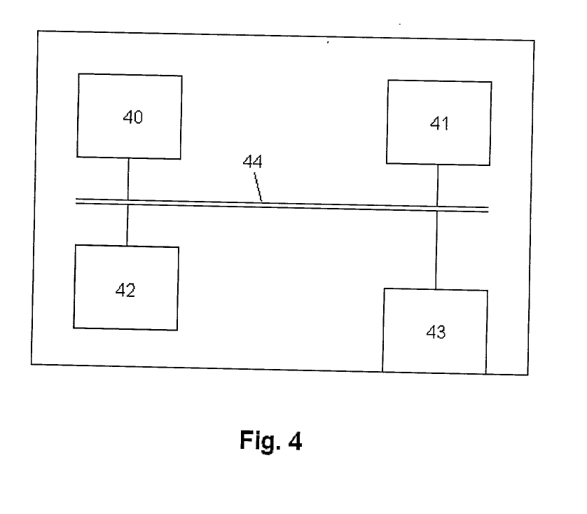

Finally, it will be appreciated that the end stations 3 must also be capable of communicating via the communications networks 2, 4, 5, as well as accessing web-pages or the like. Accordingly, each end station 3 typically includes a processor 40, a memory 41, an I/O device 42, such as a screen and keyboard, and an interface 43, which are coupled together via a bus 44, as shown in FIG. 4. In this example, the interface 43 is used to connect the end station 3 to either the Internet 2, or the LANs 4,5 and accordingly, will be formed from a modem, Ethernet card, or the like, as appropriate.

Accordingly, the end stations 3 could be formed from a personal computer, a lap-top, palm-top, an Internet terminal, an Internet enabled television, or the like, which is executing applications software to allow web browsing to be performed, such as Internet Explorer™, or Netscape Navigator™, or the like.

### Functionality

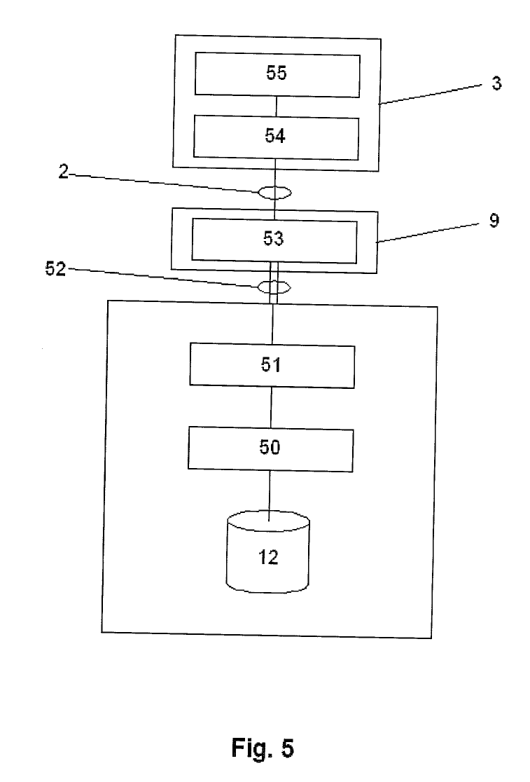

An example of the functionality of the system of the present invention is shown in FIG. 5.

As shown, the base station 1 includes the database 12 coupled to a database management application 50 executed by the processing system 10. In this example, the database management application is formed from a modified version of Studio Central version 3 produced by a Silicon Graphics Inc, the operation of which is described in the U.S. Pat. No. 6,181,336.

The database management application 50 operates to control the storage of data in and the retrieval of data from the database 12. The database management application 50 interacts with a server application 51, also executed by the processing system 10, which is adapted to enhance the database management application 50 by provided additional services to users of the system. The additional services, which will be explained in more detail below, include the use of a dictionary for parsing queries and keywords, the use of quantifiers, the use of a classification scheme to aid with locating content and the provision of the work flow management.

In addition to this, the sever application 51 is adapted to receive commands in a predetermined XML format and then translate these commands into a query language accepted by the database management application 50.

The base station 1 and hence the server application 50 are coupled to a client server 53 that is implemented by the processing system 9 as shown. The client server is coupled to the interface via a TCP/IP link 52, which may comprise the Internet and one or more other communications networks, such as the LAN 5.

It is possible to have any number of client servers co-operate with a single base station 1 via respective TCP/IP links 52. This will allow for example different client servers 53 to be implemented at different locations. Typically, the content in the database is divided into a number of domains, as will be explained below, and a respective client server 53 may be provided for each domain.

In this case, each client server 53 is provided with a respective unique identifier that is included in any XML messages transferred via the TCP/IP link 52 allowing the sever application 51 to uniquely identify the client server 53 with which it is communicating.

The client server 53 co-operates with an Applications Program Interface (API) 54 that acts as an interface between a web browser 55 such as an Internet Explorer™ or Netscape Navigator™. The client server 53 and the API 54 are executed by the processor 40 of one of the end stations 3 that is coupled to the client server 53 via the Internet 2 or one of the LANs 4, 5.

In use, operators of the base stations 1 are able to add content to the databases 12 using any one of the processing systems 9. In particular, as the base stations 1 are linked, this allows content to be updated in both databases 12 simultaneously. This provides redundancy such that if one of the databases 12, or the base stations 1 fail, content can still be obtained from the other system.

The content is entered into the databases 12 by storing each individual item as a respective content instance, with details of the content being stored in the form of metadata.

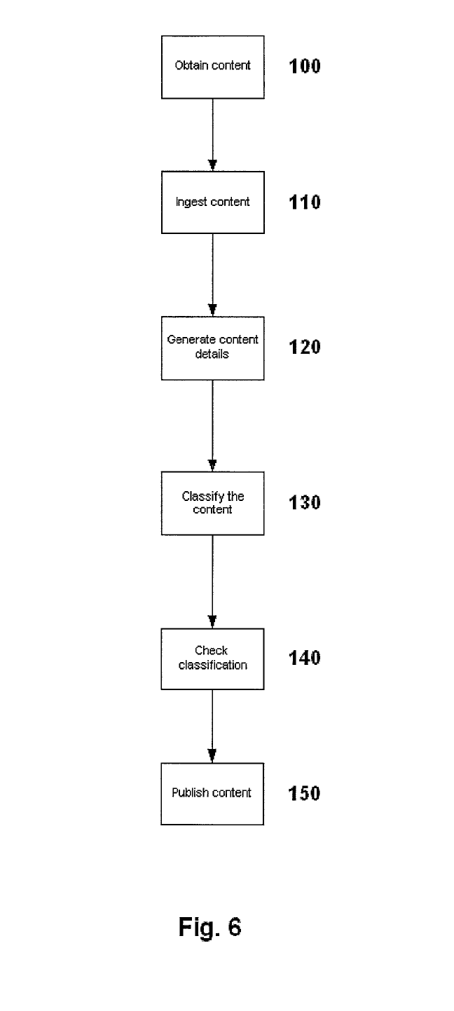

The technique used in this process is outlined in FIG. 6. As shown, the process involves firstly obtaining and then ingesting the content as shown at steps 100 and 110. This process effectively involves receiving a digitized version of the content or digitizing the content for subsequent storage in the database 12. Once the content instance is ingested, the user inputs content details 120 which are used to locate the content during retrieval searches.

At step 130 the content instance is then catalogued. In this particular operation, the content details defined by the user are used to assign the content to a hierarchical classification scheme to order aid subsequent retrieval of the data. At step 140 the classification is checked manually, before the processing system publishes the content by storing the content in the database at step 150.

Once published, users can view the content using the end stations 3. This is achieved by having the user log on to a web site generated by the processing system 3. The user then accesses a web page that provides a query form, allowing the user generate a query.

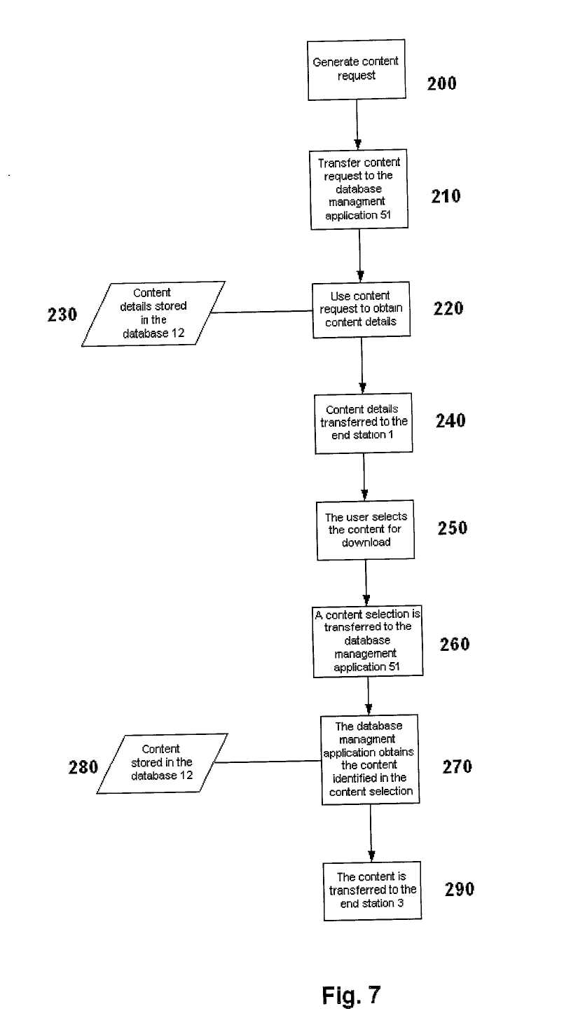

As outlined in the flow chart shown in FIG. 7, once the content request is generated as shown at step 200, the content request is transferred via the API to the client server 53. The client server 53 translates the query into a number of XML messages that are transferred via the TCP/IP link 52, to the server application 51. The server application 51 interprets the XML messages transfers the content request to the database management application 50 at step 210.

The database management application 50 uses the content request to query the database and locate relevant content instances. As shown at 220 and 230, the database management application 50 obtains content details that are representative of the content located by the query, transferring the content details to the end station at step 240. Thus, rather than return high volume data in response to the search, the database management application returns content details including low volume representation of the content instances. Thus for example in the case of the images stored in the database 12, as will be explained in more detail below, the content details will include a low resolution proxy image allowing the user of the end station 3 to determine whether the image located by the search is acceptable.

As shown at step 250, the user then selects the content for download, causing the end station 3 to generate an content selection, which is transferred to the database management application at step 260.

The database management application uses the content request to obtain the selected content from the database 12 as shown at steps 270 and 280, before transferring the content to the end station 3 at step 290. The actual techniques used in the process will be described in more detail below.

### Features

Some of the features of the system will now be described in more detail.

### Domains

The stored content instances are associated with respective domains. Each domain is a collection of content instances that are related to each other in some way. Thus for example, a domain may define content belonging to one particular company, or user. Some of the functionality provided by the domains includes:

The system can be set up with 1 to N different domains.

Security features such as authentication, roles-based permissions, rules, etc. are all associated with a given domain (although a parent-child relationship exists such that more granular control over security is possible at the asset level).

Domains can contain sub-domains (also known as Collections) for the purposes of dividing a domain of content into logical groups. An arbitrary number of levels of domain/sub-domain hierarchy may be utilized.

The domain concept permits multiple asset libraries and front-end web-sites to be driven from one server application installation, each with their own security models, fulfillment models, transaction models, workflow, etc. Different domains can even support entirely different vertical applications (e.g. Domain A=stock media library; Domain B=brand asset manager).

The domains may be either commercially available or non-commercial and restricted to a specific set of people (e.g. company employees).

The same content may exist in several domains concurrently. In addition to this, domains may be public, such that they can be accessed by any user of the system, or private such that they can only be accessed by pre-specified users.

In either the private or public domain, the collection user is billed on usage. In a private domain, the collection owner (or a nominated third party) is also the user. In the public domain the content is commercially available to anybody.

It is also possible, to restrict access to content in the public domain to certain users. For example, make Greenpeace content unavailable to oil companies.

### Metadata

Each content instance has associated content details that are stored as metadata. There may be several types of metadata associated with any content instance. The types of content details, and in particular content data that may be defined as metadata for each content instance include:

Keywords: one or more keywords may be provided that are representative of the respective content instance and are entered by the operators when the content is first stored in the database.

Classifications: a hierarchical thesaurus of subject terms for the purposes of providing accurate and consistent classification of subject matter. For example, a historical video about the Rum Rebellion might be classified under:

Documentaries: History: Australian History: 1800-1850: Rum Rebellion

Content may be classified under more than one category. For example, the above mentioned video asset might also be classified under:

People: Historical Figures: Australian History: Captain William Bligh

Classifying content in this manner feeds the search engine which customers use to find content. The more accurate and complete the classification, the more powerful and useable the search engine and search results.

Quantifiers: content instances can have arbitrary quantifiers associated with them. A quantifier is a “slider” with minimum and maximum values. Can be used for adding any quantitative value to an asset (e.g. Angle of View, Depth of Field). Has been used in tests to add “subjective” attributes to content instances (e.g. “Urgency—Calm<> Frantic”, “Happiness—Sad<>Happy”, etc.). Java 2 API provides a “Subjective EQ” or “Feelings-Space Sliders” for the purposes of searching for content instances on this subjective basis. This has been proven demonstrably valuable to searchers who are not searching by subject matter, but for an asset which conveys a particular concept or mood.

The metadata associated with a content instance can be created, modified and deleted using the processing system 9. The metadata can also be associated with or disassociated from a domain. Metadata can be associated with many domains. All metadata modifications are access controlled.

In addition to the metadata outlined above, general metadata is also provided including a dictionary and thesaurus that ensures correct spelling, resolves ambiguous definitions (e.g. “stable” can mean “calm” or it can mean “a place to keep horses”) and resolves synonyms to a canonical form (e.g. “forest fire”=>“bush fire”).

The dictionary and thesaurus provide the means to verify and offer alternatives to terms entered when querying or storing content instances. A single family of server application services provides all dictionary and thesaurus features by accessing the metadata. Domain specific dictionaries can be installed and registered to particular domains. This allows a general purpose dictionary to be extended in a way specific to each domain. It is also possible for the dictionaries to be altered by the user of the system to generate domain specific dictionaries.

### Searching

The query form allows the user to query the database using a number of different techniques, including the use of keywords, classifications, and quantifiers.

Features provided by the searching include:

A “simple query”, whereby keyword(s) are entered and processing system performs a search against classifications, then keywords, then other associated metadata.

Search results are ranked according to relevance. Classification matches are given a higher weighting than keyword matches. Weights are summed and results are sorted to produce ranked search results.

Users can browse through search results using lower resolution proxies (thumbnails) of the content instances.

Once an item has been selected from search results, a larger proxy is generated for viewing and associated metadata is displayed.

Users can also browse through the classification hierarchy(ies) which are associated with the selected domain of content, and retrieve all content instances with a matching classification.

Advanced Search permits the construction of complex Boolean queries using a Query Builder. Criteria are added line-by-line to the Query. The Query is then executed and content instances which satisfy the criteria are returned. Criteria which can be specified include all metadata attributes. Boolean comparison operators can be used, including “greater than”, “equal to”, “less than”, “not equal to”, “contains”, “does not contain”.

The use of wildcards in the keywords to cover many terms simultaneously.

### Authentication

Users are required to log onto the system. They will be authenticated against user data stored in the database 12 (in the form of an LDAP database). All operations are authorized against an access control. User identification is linked to a random session identifier, significantly reducing the probability of masquerading.

Access to content and capabilities within the system are restricted to specific roles and people. The access control services provide authentication and authorization and the means to administer users and the level of access control they are permitted 9. They also allow organizational hierarchies to be represented—this is useful for workflow, for example, where escalation to a related role or person needs to occur.

### Workflow

The processing system 10 provides a workflow functionality to allow processes to be distributed between different operators working at different processing systems 9. Workflow is the automation of a business process (or part thereof) that involves interactions with people and systems. Typically, such processes involve a number of people and systems and are generally long-lived.

Thus, the workflow procedure is adapted to allow different operators of the processing systems 9, 10 to perform different tasks with respect to the classification and storage of data. Accordingly, a number of workflows defining the procedures for storing and classifying content are stored in the database 12.

Thus, for example, a general workflow will be defined which is similar to the procedures outlined in FIG. 6. This allows the storing process to be divided between a number of operators, with each operator performing respective one(s) of the steps 100 to 150.

In order to achieve this, when content is received, an indication of the content is added onto a workflow list that sets out the content that is to be processed for each task. Accordingly, each operator will then be presented with a list of the task to which they are assigned, the list indicating the content to be processed.

Thus, an operator performing the ingesting task 110 will be presented with an indication of the content that is to be ingested. Once the content is ingested, the indication of the content will be removed from the ingestion workflow list, instead being presented on the workflow list for the generation of the content details. This workflow list will be presented to a respective operator allowing them to perform the task as required. This is repeated for each task in the workflow, until all tasks have been completed.

It will appreciated from this that the workflow lists are associated with operators such that each operator can perform different portions of the workflow corresponding to different tasks. In order to achieve this, each operator must be uniquely identifiable and accordingly, it is necessary for each user to log into the system. This is typically achieved by provided an authentication process, as outlined above. Accordingly, the system can be configured so that the operator can only view the tasks assigned to them.

In any event, the workflow also allows each task to be subdivided into a number of subtasks so that each subtask may be performed by a respective user. Thus, whilst the above describes the use of a set user to perform each steps shown in FIG. 6, it is possible that each one of these steps may in turn be divided into a number of steps, which are then performed by a number of respective operators.

The constituents of a workflow process are:

A set of activities;

Conditional branching between the activities;

Parallel activities and synchronization if required;

Time-based branching—this allows activities to be executed after a specified time has elapsed; e.g. escalating an activity when it has not been completed within the required time.

An activity can be performed by an actor which is a person or a system. Each actor has an associated queue called a worklist—a worklist is a list of the work to be performed by that actor. A worklist may be shared by many actors. In this case, items are processed by the first actor that is available for work.

Workflow automation provides the ability to:

Codify repeatable processes;

Report process performance (e.g. determine bottlenecks and process costs);

Re-engineer business processes.

Allow for an appropriately authorized person to re-assign and delete tasks.

Allow content management tasks to be automated and managed.

Manage the ingestion of digital content instances and the entering of subject-matter metadata using the Classification Scheme(s).

Integrate digital asset management functions and services with geographically distributed human users or other well-formed Service Providers (applications which may participate in workflows, for example packaging of content using a Digital Rights Management system prior to delivery to the customer).

Create any number of (optionally hierarchical) arbitrary workflow processes.

There are three main interfaces to the workflow functionality:

Process definition—This is a graphical interface that allows processes to be graphically designed and deployed.

Worklist—Interface to allow:

Retrieval of the details of items on a specified worklist;

Acquisition of any item on a worklist for the purpose of undertaking the required task

Completion of a task;

Release of a task without completion (The task is replaced on the worklist)

Process Monitoring and Reporting—A process can include self-monitoring (i.e. part of the process). In addition, process monitoring and reporting allows the execution time for each activity to be determined. This interface is provided using metrics generated by Oracle Workflow and reporting against the Oracle database. Any reporting tool may be used.

The primary functions for managing content that are defined in workflows include:

Scanning

Images are batch scanned with slide (or other) scanner. The scan phase will also generate the proxy images (reference image) prior to viewing by the Ingest Operator. These images are not yet checked-in to the base station (unless ingest is performed on a different machine to the scanning).

Ingest

Ingest applies factual information to each content instance such as associating customer information (e.g. customer identifier and other details) with each content instance. Groups of content instances will often share common details. Ingest may be closely coupled with the scanning. Where batch information exists (e.g. file of customer details), this can be set-up prior to scanning. Ingest will create an asset (metadata and content) in the server application for each scanned image.

Catalogue

Cataloguing provides qualitative interpretation of each content instance. This activity may be distributed to several geographically disperse subject matter experts. Cataloguing may happen some time after Ingest.

Product-ise

Product-ising assigns a set of product codes to each content instance. That is, the options for sale and use of the content instance. Product information will be available to the purchaser. Product-ising can occur in parallel with cataloguing. Assigning product codes may happen at Ingestion, or may be performed as a separate step.

Browsing/Ordering

The client will browse (execute queries) a collection and (hopefully) place one or more orders..

Packaging

Packaging will encapsulate the content instance in an encrypted form. The (encrypted) package can only be opened by an entity (user or system) with appropriate rights. Packaging occurs prior to delivery of a customer order.

Caching

Packaged content is cached in a location accessible to an FTP server that will serve to the customer. Consideration may be given to caching content “closer” to the customers. While no clear requirement for such caching has been identified, operation of the system should be open to such options.

Delivery

Delivery may take two forms, both structurally similar:

User manually downloads from an FTP area;

Automatic download manager (on user's system) downloads from an FTP area.

In either case the system will monitor whether content has been downloaded or whether there have been unsuccessful attempts, possibly requiring Customer Assistance.

The FTP server will be configured to ensure that a user sees only content destined for that user. A range of techniques could be used—from unique username/password to unique directory, or other techniques. Content that has not been downloaded after specified (configurable) period will be removed from the download cache.

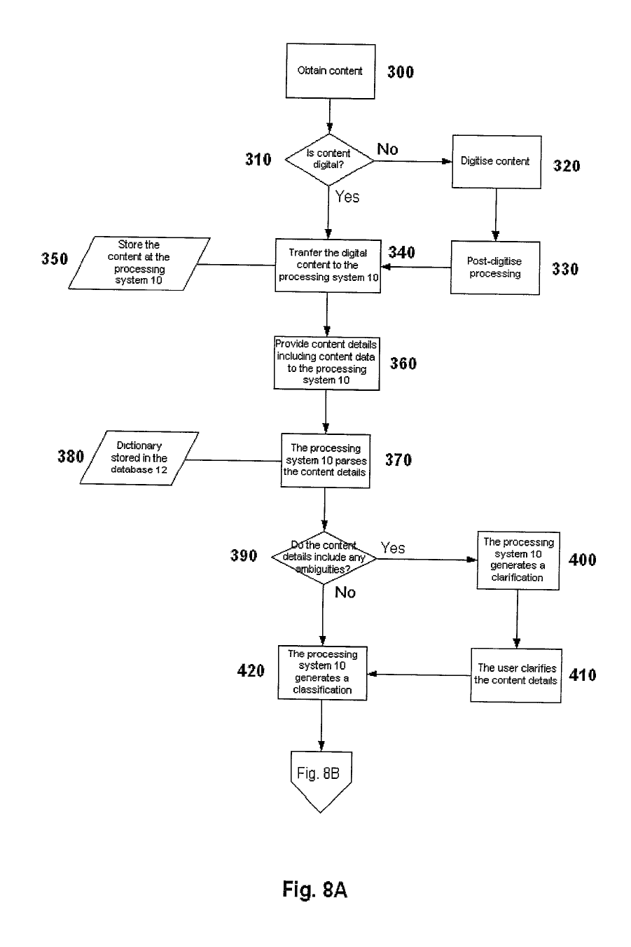

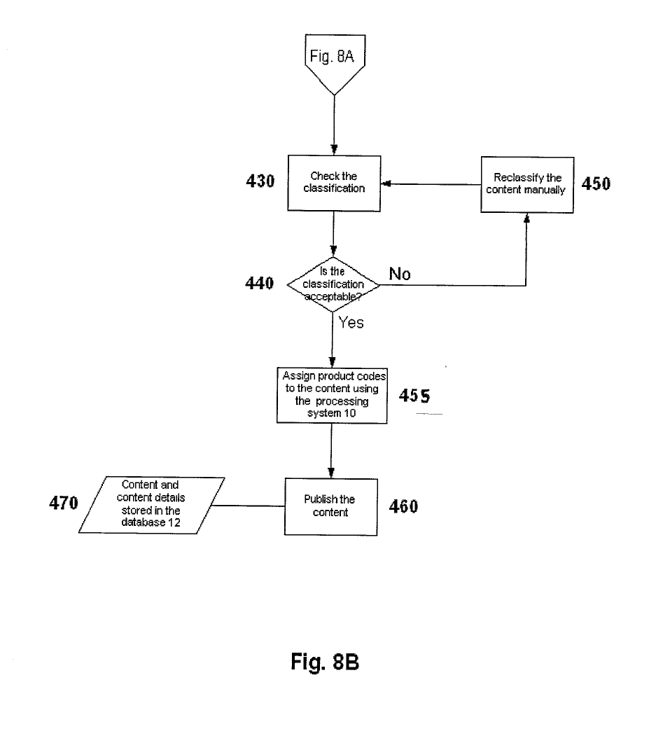

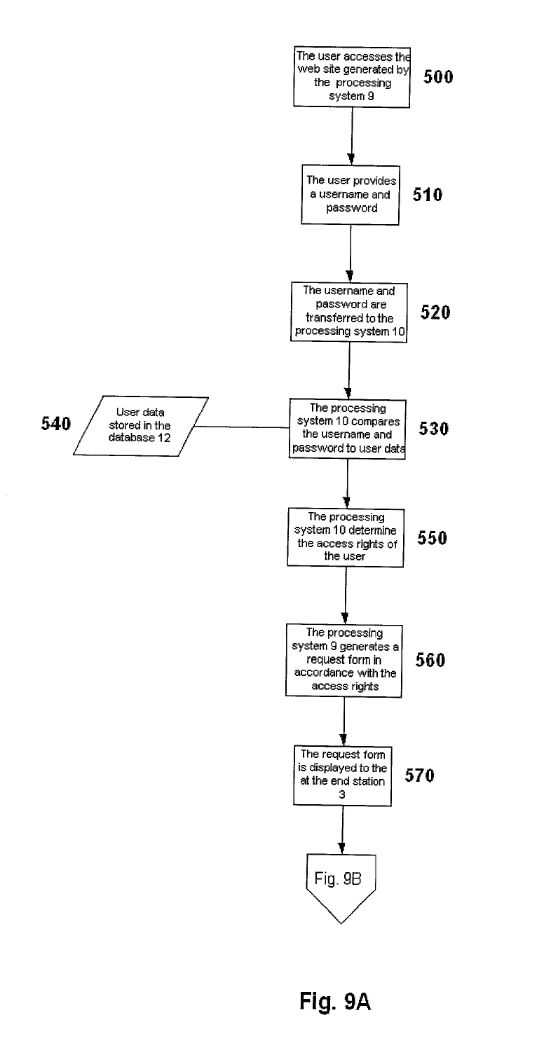

A more detailed description of the operation of the system to classify and store content within the database 12 will now be described with reference to FIGS. 8A and 8B.

As described above, this operation is typically performed by operators of the base station 1 for a number of clients. Accordingly, the clients provide the content to the operators who then operate to classify and store the content within the database in accordance with the following method.

In order to achieve this, the operators typically only require use of the processing systems 9, 10 and the database 12. Accordingly, for the classification of the storage operation, this can all be performed at the site at which the database is located. Alternatively of course the operation could be performed using a processing system 9 positioned at a remote location which is then coupled to the processing system 10 via a TCP/IP link.

In any event, it is typical for a number of processing systems 9 to be provided in order to allow a number of database managers to supply and store data within the database simultaneously, using the workflow functionality outlined above.

However, this operation not essential to the present invention. Thus, for example, each operator may process the content through all the stages of the storing and classifying procedure. Furthermore, clients may be provided with a respective processing system 9, allowing the client to enter their own content. In this case, the content would generally be for inclusion in a domain private to the client.

As the workflow functionality will be understood by a person skilled in the art, this will not be discussed in any further detail.

The method of storing and classifying data may be described with reference to FIGS. 8A and 8B. In this example, it will be assumed that a single user is performing each of the tasks, although the tasks may be divided as outlined above.

Firstly at step 300 it is necessary to obtain the content which is to be stored. This is typically achieved by having users wishing to store the content supplying a copy of the content to the database operators. Content may be supplied in any form and this will therefore depend to a large extend on the client or user, and the nature of the content.

Thus for example, if images are to be stored the images may be provided in digital form; or alternatively in printed form such as in the form of a photograph or a negative. In addition to this, the data may be also in the form of video or audio sequences, in which case the content may be provided digitally, for example via e-mail, via CD-ROM, floppy disk or the like. Alternatively the content may again be provided on an alternative medium, such as a video tape, audio tape or the like.

The next stage in the process is to ingest the content. Thus, at step 310 it is assessed whether the content is in a digital format. If not, the method involves digitizing the content at step 320 typically for example by scanning in images, or the like.

In the case of image content, for example, at least two modes of ingestion are supported, including:

Local—Image ingestion occurs at the site of the base station 1, using dedicated high volume, high-resolution scanners, and high bandwidth connections to the RNA server.

Remote—Image ingestion occurs at the user's site, where the images are already in an appropriate digital format. A connection exists between the users end station 3 and the base station 1 to allow content to be transferred at a reasonable rate.

Once the data has been digitized, additional processing is usually performed at step 330 to ensure the digitized content is of optimum quality. In the case of images, this typically involves using an application software package, such as a Adobe PhotoShop™, to clean the images by removing any scratches, dustmarks or the like. It will be appreciated that in the case of video sequences or audio data, alternative post scan processing will be performed at step 330.

Once the content is provided in an electronic digital form, the method proceeds to step 340 to transfer the digital content to the processing system 10. At this stage the processing system 10 operates to store the content temporarily as shown at 350.

In the case of images or video sequences, the content is stored on the processing system 10 in its native format. A proxy image, which is a low resolution version either of the image, or of one of the frames in the video sequence that is representative of the entire content instance, is then generated. The proxy image is usually a 1024×768 pixel, JPEG format image, with the native format being a lossless file format, such as TIFF image.

Once the content has been stored in the database 12 it is then necessary to catalogue the content. This is achieved by providing content details, and then using the content details to assign the content to a classification scheme.

The content details generally include details of the type and source of the content, an indication of any domain associations, and content data representative of the content. This content data is provided by having one of the database operators examine and assess the content. Accordingly, as the provision of content data is a subjective exercise, it is preferable to use operators consistently to ensure consistency of the entered content details. Accordingly, the operator is typically authenticated as a cataloguer and the set of domains which the operator is authorized to catalogue is confirmed before an operator may provide content details.

Once the authentication is complete, the operator provides the content details, including the content data 360. This generally includes one or more keywords representative of the content, together with one or more quantifier values relating to different features of the content.

The quantifiers are defined using the interface application and correspond to parameters that may be set for each content instance. The quantifiers may be defined by the database operators to allow any details of the content to be specified. Thus for example the quantifiers may be used to specify a range of values, such as the depth of field of an image, the speed of an image (i.e. whether the image is of stationery or moving objects), or whether an image is happy or sad.

Thus for example, the quantifiers may be defined on the basis of subjective properties of the content, with corresponding values being assigned to the content, such as, for example:

Happy: 75

Serene: 25

Lucid: 95

The quantifiers may be set to any value at all desired by the operators as long as this value is then used consistently for all images, or all content added to the database. In general, the entry of quantifier values may be achieved through the use of a GUI, such as a number of sliders. This advantageously provides an intuitive interface for the values to be entered. However, any technique may be used.

The quantifiers may also be set with tolerances allowing matching to be performed over tolerance ranges, as will be described in more detail below, with respect to the retrieval searches.

The content may be ingested in batches allowing a number of content instances to be grouped together. In this case, this allows content details common to each content instance to be defined for the entire batch. Thus, for example, the source and type of content may be set for each content instance in the batch. This information is then propagated to the content details defined for each content instance, thereby reducing the need for operators to repeatedly define identical information. The use of batches is also useful for managing the ingestion of content instances into the system, as well as for quality assurance purposes (tracking a set of content instances through a given workflow process).

In addition to the content data outlined above, additional content data is automatically generated and stored by the processing system 10, including information such as the ingestion time, the domain details, content file attributes, and the like.

Following the ingestion stage, the processing system operates to classify the content using the supplied content details and the content data. In order to achieve this, the processing system 10 parses the content details to determine if the content details are acceptable and in particular to determine any ambiguities including spelling errors, synonyms or semantically non-unique terms 370.

In order to achieve this, as shown at 380, the processing system 10 accesses one or more dictionaries stored within the database 12. The dictionary used may depend on the domain, or the content being classified and therefore may include non-standard terminology required to describe the content. Furthermore different language dictionaries may also be provided for storing content data in different languages.

In any event, when the processing system 10 parses the content details, the keywords are compared to the selected dictionary and thesaurus to determine if there are any ambiguities, including spelling mistakes, synonyms or non-semantically unique words.

Thus for example, if an image is described as relating to a bush-fire, the thesaurus will determine that bush-fire is equivalent to forest fire and therefore flag this as an ambiguity. Similarly, if the word “stable” is used as a keyword, the word is semantically non-unique in that it could refer to either a horse stable or alternatively to the fact that an object is well balanced.

Accordingly, in these cases the processing system determines the ambiguity at 390 and generates a clarification that is displayed to the database operator at 400.

In the case of a semantically non-unique word, the clarification will set out each possible meaning of the word and ask the user to indicate the correct meaning. Similarly, with synonyms or spelling mistakes, the clarification will indicate their intention to exchange the specified word to an alternative word as set out.

At step 410 the user either excepts the proposal or clarifies the content details. At step 420, once the details are accepted, the processing system 10 uses the defined content details to generate a classification at step 420.

This is achieved by comparing the defined keywords to the hierarchical classification scheme outlined above. The hierarchical classification scheme includes categories for potentially every content instance that may be stored. These categories are therefore divided and sub-divided to allow the content to defined. Thus, for example, categories may include natural objects, man-made objects, or the like. Then within man-made objects the categories may include buildings, vehicles, etc.

The processing system determines any matches between the keywords and the classification headings, assigning the content to the category in response to a match. It will be appreciated that if several keywords are used it may be possible to include the content in several different categories. In this case, the content will be locatable via each category during subsequent retrieval searches.

At step 430 the list of categories within which the content instances have been classified is displayed to the database operator. At step 440 the operator determines if the classification is acceptable.

To aid this process, particularly in the subjective area of feelings space defined by the quantifiers, other content instances with matching content data will be located and their proxies displayed. Content instances used for comparison purposes may be within the current domain, or within another domain which the cataloguer is authorized to view.

If the classification is not acceptable, the operator will re-classify the content instance manually at step 450. Once the classification has been deemed acceptable, the processing system 10 will then assign product codes to the content 455.

Finally, at 460 and 470, the content is published such that the content can be retrieved by users of the system. This involves storing the content in the database 12, and storing the content details (including the content data), the classifications, the product codes and the proxy image as metadata.

The manner in which content may be retrieved will now be described in more detail.

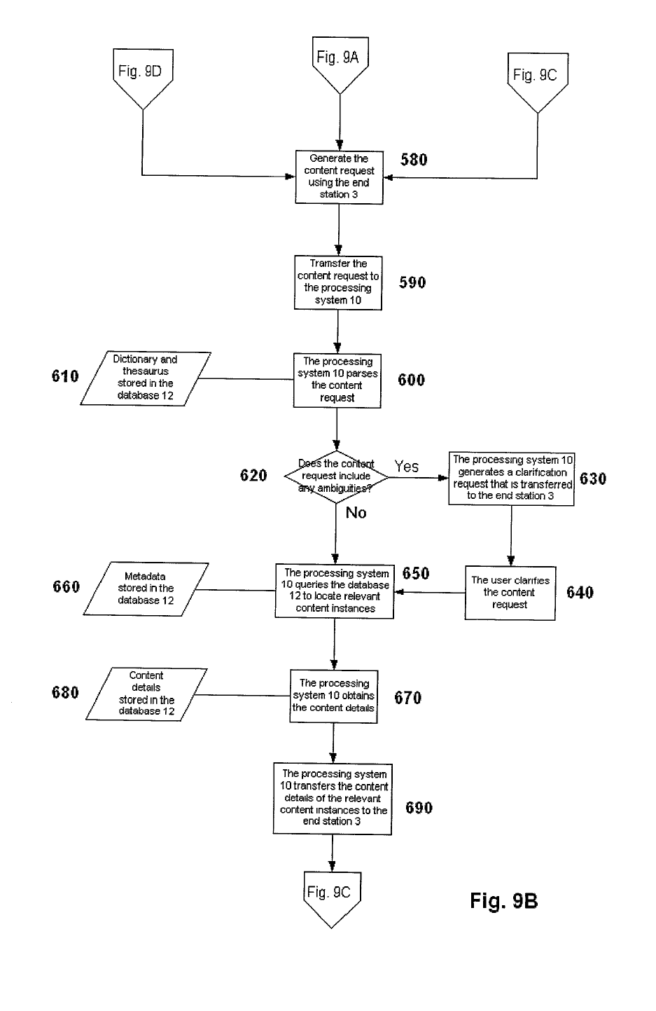

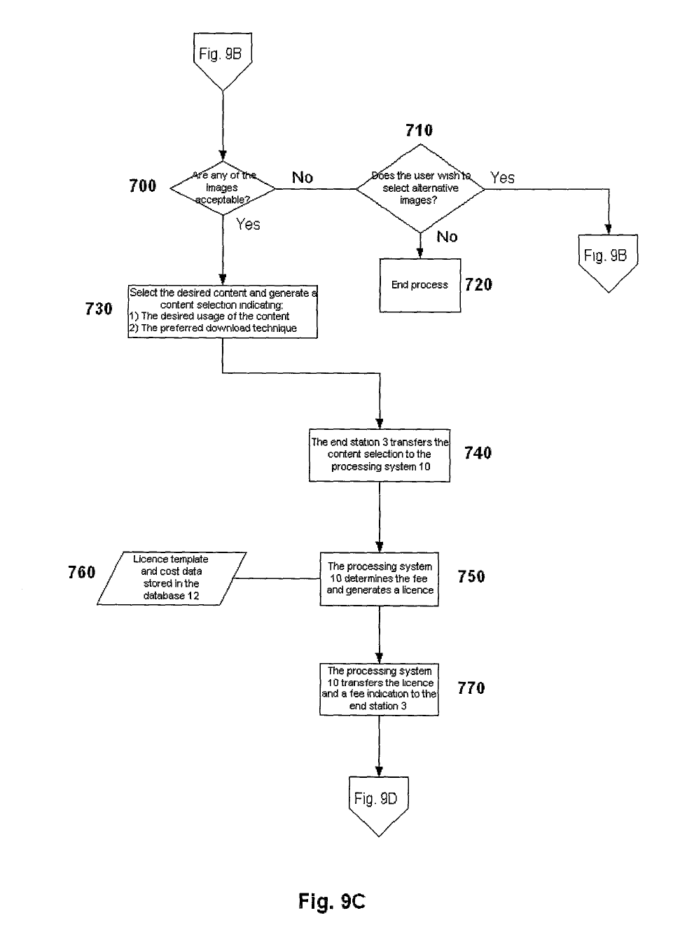

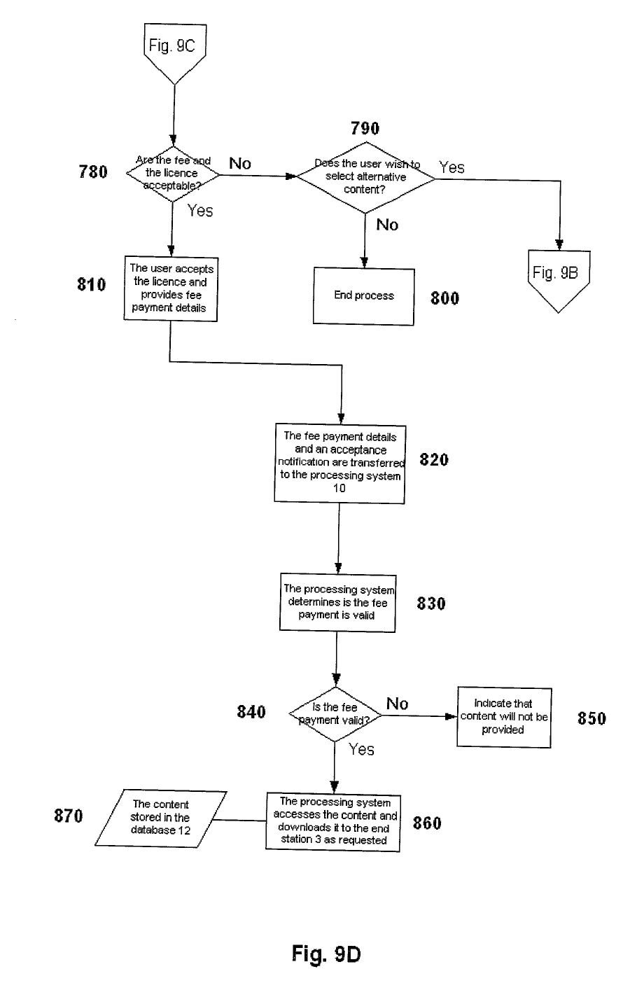

An example of the content retrieval technique according to the present invention will now be described with reference to FIGS. 9A, 9B, 9C and 9D.

As briefly described above the content retrieval may be performed by a user of one of the end station 3 by having the user fill in a request form displayed using web browser applications software 55.

Accordingly, in order to be able to access the system, the user of the end station 3 must first log onto a web site, or the like, generated by the processing system 9, at 500. In order to achieve this, the user will typically be required to provide a user name and password at 510 and 520 in order to satisfy the authentication requirements outlined above. The user name and password are checked against user data stored in the database 12 at 530 and 540.

Typically, the user data will also indicate for each respective user, access rights to the database. Thus, for example, the user data will generally indicate the domains to which the user has access. The processing system determines these access rights at 550.

The processing system 9, then utilizes this information to generate a content request form which is presented to the user as a web-page on the user's web browser 55, at 560 and 570. It will be appreciated by persons skilled in the art that the request form may be tailored according to the content associated with the respective domain the user can access. Thus, for example, a domain may contain only video images, in which case the content request form may be specific to video images.

In any event, once the content request form is displayed to the user at the end station 3, the user can fill in the request form providing details allowing relevant content to be located. As outlined above, the searching can be performed on the basis of keywords, classifications, and/or quantifiers. Accordingly, the content request allows keywords to be defined, classifications to be selected from drop down lists, and quantifiers to be defined using sliders.

The query form also allows the different searching techniques to be used in conjunction using Boolean logic combinations, as will be appreciated by the skilled person.

Once the content request form is completed, and the content request generated, as outlined in step 580, the content request is transferred to the processing system 10 at step 590. At 600 and 610, the processing system 10 parses the content request using the dictionary and thesaurus stored in the database 12.

As in the case of storing the content, the processing system 10 determines if the keywords include any ambiguities, including any misspellings, any synonyms and any semantically non-unique terms, at 620.

If ambiguities are present, the processing system proceeds to step 630 to generate a clarification request which is transferred to the end station 3. The clarification request will highlight the misspelling, outline the different synonyms, or outline the different semantic meanings of the used keywords.

The user can then clarify the request at step 630, for example by selecting the semantic meaning, the correct synonym or spelling that is required.

Once any ambiguities have been resolved, the processing system then operates to query the database 12 to locate relevant content at 640 and 650. In order to achieve this the database management application will generate a query, such as an SQL query, which is transferred to the database 12. The database query is used to query the metadata stored in the database 12.

In order to locate relevant content, the system utilizes one of several techniques depending on the details provided in the content request.

Thus, for example, if the content request includes keywords two independent checks are performed. Firstly, each and every keyword provided in the content request is compared to each and every keyword stored in the metadata associated with the content being searched (i.e. the metadata associated with the respective domain being searched). A direct match comparison is performed such that if the keywords match, it is determined that the content instance associated with the keyword contained in the metadata is relevant.

In addition to this, the keywords are also used to access classifications in the classification hierarchy. Thus for example, if one of the categories is “buildings” and one of the keywords in the content request is “buildings”, then the processing system 10 determines that each content instance classified in the respective category is relevant to the content request.

It will be appreciated that this may result in a large number of matches for a given keyword, for example if the respective category contained a large number of content instances. Accordingly, in this case if a large number of records are retrieved from a given category, these are assigned a lower relevance than direct keyword matches.

The searches can also be performed by specifying a category and limiting the search to content classified with the specified category. Thus, for example, a keyword search could be performed on content located in a specified category.

It is also possible to locate content instances using the quantifiers. In this case, the user defines values for the different quantifiers using sliders presented in the content request form. The processing system 10 will then compare the set quantifier value, to the quantifier values set for any content being searched. In this particular case, direct matching is not necessary as it is possible to define a tolerance for the match. Accordingly, if a quantifier value is set for example at 50% it is possible to set a tolerance of 10% so that any content having a quantifier value between 40% and 60% will be determined to be relevant.

It will be appreciated that the different searching techniques can be combined using Boolean logic such that, for example the user may search for content using keywords and quantifiers, within a given classification.

Having completed this, the database 12 will return a list of any relevant records. The list includes at least some of the content details associated with the content, such as the proxy image where available, at 670 and 680.

At step 690, the processing system 10 then transfers the content details to the end station 3 for subsequent review by the user. The user determines if any of the content instances are acceptable at step 700 by viewing the content details, including any proxy images.

If none of the content instances are acceptable, the user decides if they wish to define an alternative search to select alternative content at step 710. If so, the user must then generate a new content request at step 580. Otherwise the process ends at step 720.

Assuming, however, that some of the content is acceptable, then the method proceeds to step 730. At step 730, the user selects the desired content instances and generates a content selection indicating the intended use of the desired content and the preferred download technique. The content selection is transferred to the processing system 10 at step 740.

At 750 and 760, the processing system 10 utilizes the desired usage to calculate the fee that the user is to be charged for obtaining the content instances. Obviously, in the case of private use of a company's own resources, an employee would not generally be charged for obtaining data directly, in which case this step may not be required, and the company can subsequently be billed as required. However, if the use is public, then general copyright fees are payable. Accordingly, the processing system 10 determines a fee based on cost data stored in the database 12. Simultaneously, the processing system 10 also operates to prepare a license reflecting the intended use of the content. The license is generated from a license template stored in the database 12, with the license template being populated using predetermined license terms, selected in accordance with the intended usage.

At 770, the processing system 10 transfers a copy of the license and fee indication to the end station 3. The user must then decide whether to accept the fee and the license at step 780. If the fee or license for the particular usage are not acceptable, the user may select alternative content at step 790, in which case the method returns to step 580. Alternatively, the processing may end at 800 if no alternative content is to be selected.

Assuming, however, that the fee and license are acceptable, the method moves onto step 810, in which the user accepts the license and provides fee payment details. In the case of a company employee, for example, the fee payment details may be provided in the form of an account reference. Alternatively, in the case of an individual user, credit card details may be provided.

The fee payment details are transferred to the processing system 10 at 820, which determines whether the fee payment will be valid at 830 and 840, for example, whether the respective account is still active, or whether the credit card transaction can be authorized. If the fee cannot be paid, the user is informed that the content will not be supplied at 850.

Otherwise, the processing system 10 operates to access the content and download it to the end station 3 as requested, at 860 and 870.

The downloading of data from the database 12 to the end station 3 may be controlled in any one of a number of manners. Thus, as the data is typically of a high volume, and can be inconvenient to download the data in immediate response to a request. This would typically tie up resources of the processing system 10, the processing system 9, and the end station 3 when these may be required for alternative work. Accordingly, in order to overcome this, the user of the end station 3 can indicate a subsequent download time. At this time, the user of the end station 3 logs onto the base station 1, and the data is downloaded as required. This may occur, for example, at night, when the end station is not otherwise in use.

Alternatively, the data can be provided using alternative techniques, such as transferring the data via subsequent email, or, transferring the data to a remote site from which the data can subsequently be downloaded using an FTP (file transfer protocol), or the like.

Thus, when a customer requests that high-resolution content be downloaded, an order is created to manage the process. Order management services include creation, addition, cancellation and listing of orders. Order management will maintain statistics on the number of orders made by an entity (e.g. user profile) in each domain. These can be queried later.

Default order preparation involves retrieving the high-resolution version of the content, formatting and transcoding the asset according to the user's specifications, then placing the asset on a publicly accessible FTP server for secure download. A fulfillment workflow then alerts the user via email with a one-time password to use to retrieve their asset.

Prior to delivery all content must be packaged (analogous to placing content in an envelope or packing box before posting). Packaging will encrypt the content and associate a product description.

While packaging is expected to be provided by a system similar to that describe in the co-pending Australian Provisional Patent Application Number PR7284/01, any suitable encryption system could be used.

Product Packaging services are used by the server application 51 during order fulfillment. They may also be used by any other application.

Package Delivery services encapsulate the delivery of orders. Delivery is responsible for making content available for delivery (on an FTP server) and notifying the base station when content has been downloaded by the consumer.

Package Delivery services keep track of the number of download attempts. A large number of attempts may indicate the consumer is experiencing download problems. If this happens a customer services representative will be notified so they may address the problem.

Downloads may occur through two means:

Content associated with automatically delivered orders is transferred by FTP from the base station server to the customer's own FTP site. Authentication data (user name and password) is specified when the request for automatic delivery is made.

Content associated with manually collected orders is made available at a local FTP site for a limited time. Customers are notified by e-mail of the unique URL for each content item, the authentication data needed to access the site, and the time at which the content will be removed from the site.

Automatic delivery is managed by a download manager.

It is also possible to specify format conversion allowing the format of the content to be manipulated the format (size, type) of a content instance. Conversion requires the specification of an input, the operation, and an output.

Thus for example, the content instances are typically stored in the highest resolution possible. Thus in the case of image data, the image is typically stored in the database 12 in a TIFF format, or the like. However, if the image is only required for presentation on a web-site, then it is typical for the image only to be required in JPEG format or the like.

Accordingly, rather than download the TIFF image file, the user can request that the image is provided in a JPEG format, thereby reducing the amount of data that needs to be downloaded. In this case, the processing system 10 will perform the format conversion when obtaining the image from the database 12, thereby reducing the volume of data that is transferred to the user.

Format conversion can be extended to cater for other forms of media. For example, someone may require video in MPEG-2 I-Frame, requiring a conversion from DV.

### Additional Features

Some additional features provided by the present invention will now be described.

### Session Management

The processing systems 9 are essentially stateless. If state is required, information is usually maintained in a cookie that is passed between the web-server and its client. This works for small amounts of state information. However, the performance can be degraded if the cookie becomes too large.

Session management provides the ability to keep state information on the server and simply populate the cookie with a reference to the state information. This allows large amounts of state to be maintained whilst keeping the cookie small.

The scope (lifetime) of the state is constrained to the lifetime of a session. The definition of session can be arbitrary. The most probable event that denotes the start of a session is when a user logs into the system. Alternatively, it might start at some other time controlled by the application, triggered by a significant action or state of the system.

Sessions can be nested. That is, the state information may be pushed and popped from a stack. This allows the interface to easily move between different contexts.

Session management provides the ability for the calling application to create and destroy sessions and store arbitrary information in the form of key/value pairs. If a session is not explicitly destroyed by the caller, it will be garbage collected at an appropriate juncture.

Sessions are not normally associated with a specific user. However, the session management services allow the application to associate a unique key (such as user identification) for retrieval. This provides the ability to cater for situations where users are unexpectedly disconnected—upon reconnection; their last session can be retrieved.

### Profile

Profile services allow a user to keep personal preferences, store favorite queries, etc. The type of data kept is up to the application—profile services provide the means of associating arbitrary data (key/value pairs) with unique user identifiers. The RMA may use these services to keep track of when users last logged on, how often they use the service, etc.

### Statistics

By recording and interpreting statistics on strategic operations, it is possible to understand the system's usage and performance patterns. This understanding will allow operational, software and hardware productivity improvements to be targeted.

Base station clients are responsible for selecting operations on which to record statistics. These services automatically record the date and time at which the specified statistics record is modified.

### Logging

The base station will record significant events in persistent logs, for subsequent inspection and analysis. These events that are recorded include:

System startup and shutdown

Administrative operations, e.g. backups

User authentication success and failure

Dictionary/thesaurus creation and deletion

User session management creation and deletion

Asset ingestion

Metadata definition

Order creation

Order delivery

The logs are managed by the base station but present a public interface for inspection..

### Graphical User Interfaces

The base station provides graphical user interfaces (GUIs) for ingestion, cataloguing and general system administration operations. In general the GUIs include the following features:

Clients of the base station services—The GUIs are clients of the base station services and connect to the base station using TCP/IP over local or wide area networks. Local or remote operation is therefore supported.

Java implementation—The GUIs are implemented in Java, which allows them to run on any platform with a Java Run-time Environment (JRE), including Win 9X/NT/2000, Macintosh, Linux and Unix workstations. Usability—The GUIs observe well known usability principles, including consistency of look and feel, efficiency of operation, and learnability. On-line help and context sensitive pop-up tips support new and experienced operators.

Security—The GUIs utilize the base station authentication services to ensure that only appropriately authorized individuals can operate the system.

Flexibility and extensibility—The GUIs are expected to change over time in order to improve efficiency and meet changing and emerging requirements. Where possible, this should be taken for account in the design so that changes can be made within the original framework.

### System Administration

The System Administration GUI serves multiple functions via a tabbed, extensible and configurable interface. The availability of each function within a specific instance of the System Administration GUI depends on user authentication and access control. That is, only the most privileged user will have access to all functions.

Startup/shutdown—Startup and shutdown the base station, its components and underlying services (including the database management application 50 and the database 12).

Operating status—Display operating status data, including:

Current users;

Storage in use and free

Statistics of managed content instances, organized by domain;

User administration—Create and delete users, assign roles and privileges, manage passwords;

Global configuration—View and alter global configuration data, such as password ageing, query tolerances, maximum size of query results, etc.

Log inspection—View system logs through definable filters, such as event types, date ranges, etc.

Dictionary management—A set of dictionary and thesaurus management services, including:

List installed dictionaries and the domains and metadata to which they are registered;

Manage dictionary registration;

Create a new dictionary and ingest its content from a file;

Delete a dictionary;

Query a dictionary (or set of dictionaries);

Define or re-define a term in a dictionary (or set of dictionaries).

Profile management—View and modify customer profiles.

Domain management—View and modify domain characteristics, including (ASP) customer details (such as LDAP server address), statistics on content instances under management, associated metadata and dictionaries, details of subject matter experts (cataloguers).

Metadata configuration—View, define and redefine metadata and their association with domains.

### XML Examples

The following examples are expressed using XML. The operands are nested within an operator to allow precedence to be specified. In this example, the XML message is used to find the stills under the category “people” where those people are very happy.

<RNQL COMMAND=“FIND”>

<WHAT TYPE=“STILL”>

<OPERATOR TYPE=“AND”>

<CATEGORY>People</CATEGORY>
<EMOTION>

<TYPE>Happy</TYPE>
<VALUE>100</VALUE>

</EMOTION>
</OPERATOR>
</WHAT>

</RNQL>

### Storage Management

A Data Migration Facility product (DMF) can be used to manage storage for the database. Based on configurable criteria, the DMF will use robots to migrate files between (relatively expensive) on-line storage and (relatively inexpensive) off-line storage, transparently to the user.

The amount of on-line storage can be increased as the number of content instances being stored increases. The DMF allows the storage configuration to be readily changed. Off-line storage can be provided by a tape silo.

### Base Station Clients

Clients may be of any type and may arise from many types of interfaces to people and systems. The underlying services are client agnostic. Two key types of client are represented in the Operational Architecture:

The Front of House (FOH) client is a browser-based interface providing access for potentially thousands of users per domain. These stateless interfaces are served from a web-server. The FOH client is the combination of both the browser and the web-server.

The Back of House (BOH) interfaces are used by tens of people per domain to administer the domain and ingest and manage the content. Other interfaces may be added as required.

Front of House (FOH) clients access commercial and non-commercial domains using specific portals. These are browser-based interfaces that access the base station services using HTTP 2. The Back of House (BOH) interfaces are used by authorized people to administer the system and to ingest and catalogue content. Both FOH and BOH clients log onto the system to create a unique session—the session is managed by the base station. For FOH clients, a unique token (cookie) is passed back and forth to the client browser by the web-server. The token (a session identifier) may be passed via the URL rather than as a cookie in order to accommodate users who have cookies turned off.

Because the client is loosely coupled (and stateless) sessions will be garbage collected at an appropriate juncture. The browser-based clients are served by a web-server operating on one of the base station servers.

FOH clients may also operate a download manager. The download manager may be invoked immediately (as opposed to via a scheduler) by the user—it would then query the order queue to determine if there were any files for this user to download at this time. The user would then be given the option to download immediately or at a later time. Users will be given the option to throttle their download to a certain bit rate.

The download manager can run on a separate machine to the machines used for browsing. Consequently, there is no restriction on the platform for the web-browser.

The BOH clients are Java based thick-clients. They access the BASE STATION services using a proprietary protocol over TCP/IP.

Communications between clients and the base station services are insecure. That is, there is no encryption of the messages or content sent between the clients and base station services. Should encryption between the various clients of the application and the base station services layer be required, due to an ASP customers requirements, this may be achieved using 3rd party VPN technology which need not integrate with the base station services.

### Base Station Services

The system is operated on a redundant server and storage configuration to achieve high levels of availability. The server application, the database management application, the database and the DMF operate on a pair of processing systems.

These services and applications are distributed across both servers in order to increase performance, rather than simply using one machine for passive standby.

Similarly the Web Server and FTP Server operate on a further pair of processing systems. The Web Server and FTP Server are separated from the other applications for security reasons.

The computers and storage should be housed at different sites to cater for a catastrophic failure of one site. The maximum separation depends on the type of fibre optic cable employed:

Multi-mode fibre has a maximum operating distance of 300 meters.

Single-mode fiber has a maximum operating distance of 2 kilometers.

As indicated, each site has a computer and co-located storage. The local storage is configured with enough disk to support the services of both servers. The storage systems are interconnected via a Fiber Channel switch. The local system-to-switch-to-disk interconnects are copper based. These have a maximum operating distance of 30 meters. If larger separation is required, the copper can be replaced with optical fiber. Each computer can reach either storage system in the event that services are failed over from one computer to the other. In this storage area network (SAN) configuration only one computer may own and access a given disk unit; that is, it is not a clustered file system.

During fail-over, control of the disks will be passed from the failed computer to the other computer. For full redundancy both sites have a tape silo. In combination with DMF, the tape silos provide near-line storage management the purpose of migrating content that is infrequently used to cheaper tape-based storage. The full resolution content will only be accessed during fulfillment, which is an asynchronous activity. The cost overhead (orders of seconds) to retrieve the content from tape to on-line disk storage is insignificant for fulfillment.

The processing systems 10 can be interconnected with a fast (e.g. 1000BT) private network connection to allow the migration of content between different services on each node. A private network connection is used by the high-availability software (FailSafe) to test the status of the services on the other node—this is provided in addition to the public network interfaces to allow FailSafe to detect whether there is a failure in the system or the network interfaces. Likewise, remote management should be via a separate management network.

Packaging servers are located in each site. With normal operation, packaging is performed on nodes “near” to a FTP server. These servers are replicated, if necessary, to improve packaging throughput. Redundant servers are provided at the alternate site. There may be fewer servers (and lower throughput) because the probability of failure is low—however, these systems are relatively cheap so providing full redundancy may be viable.

The public network between the clients and the base station services should have redundancy. The network connection between the base station servers and the Packaging servers should also have redundancy. The LDAP server may be provided by an external customer. If the service is local, it can be hosted on the redundant IRIX servers.

Typically the first site will operate the following main software services:

Web-server—Using Java servlets, this provides the bridge between the browser based clients and the processing system 10. The servlets will communicate with the other site using a custom protocol over TCP/IP.

Server Application Service—This is an exact replica of the service running at the other site. However, the web-server has been statically configured to attach to the server application. This means the local Server Application Server will handle browsing, and ordering traffic, whereas the Server Application Server at the other site will handle ingest, catalogue and fulfillment traffic.

Samba—Content to be packed on one of the packaging servers will be accessed via. The packaged content can similarly be stored on the Server Application (in a location for access by the FTP server) using Samba.

Content Store—This is the store (or set of stores) used by the database management application keep content. It operates at this site A so that it is local to the Web Server—this reduces the amount of network traffic between the two sites.

DMF—Data Migration Facility. This automatically migrates data to/from the tape silo to on-line disk.

FailSafe—IRIS FailSafe is software that allows services on one node in a cluster to be automatically migrated to another node in the event of a failure. If a server at Site A fails then its services will be migrated to the corresponding server at Site B.

The second site will operate the following main software services:

FTP Server—The FTP server serves content during manual or automatic fulfillment (using download manager on client).

Server Application Service—This is an exact replica of the service running the first site. In normal operation the only clients are the BOH clients. They are statically configured to attach to the Server Application Server at the second site. This means that this server will handle ingest and catalogue traffic, as well as order fulfillment traffic.

Database Management Application—Database Management Application content management services.

Workflow—This is the workflow engine. It runs within the database, so it must be located on the same server. A listener will bridge Workflow queuing with Server Application services. The communication between the bridge and server application services will be via a TCP/IP connection.

Database—The database for metadata managed by the Database Management Application as well as data managed by the server application services directly.

FailSafe—IRIS FailSafe is clustering software that allows services on one node in the cluster to be automatically migrated to another node in the event of a failure. If there is a system failure at the second site, then the services will be migrated to the corresponding server at the first site.

### General Operation

As indicated, the server application services are exact replicas. Both operate services for Session Management, Access Control (authentication and authorization), Thesaurus, process metrics, as well as encapsulating Studio Central asset management services. Authentication will be provided using LDAP services via the name service daemon. The server application will perform authorization checks, regardless of any checking done in the client (which is done for improved interface usability). For example, queries will be intercepted before execution to ensure the caller has the authority to query the specified metadata—the server application will generate AQL and perform the query on behalf of the caller.

The server application service is independent of the type of client; that is, it does not differentiate FOH web-based clients from BOH “thick-client” or any other type of client, except on the basis of the level of authorization granted the user. This allows different types of clients to be created without changing the server infrastructure.

As indicated, server application services will use the database management application for content management. It will communicate with database management application via the network interface (AMP). This provides the option to relocate database management application to another machine if required. Both the database management application and the server application services maintain persistent data in a database. Typically both components can communicate with the database using SQL. If required, the database could be relocated to another machine.

For security reasons, external telnet sessions to the database management application will be disabled, eliminating the ability to bypass the additional security in the server application services.

Workflow provides process automation using a combination of PL/SQL in the database and a workflow daemon. A plug-in will bridge database management application to the workflow engine—when an asset is checked-in and the workflow state has changed, the plug-in will trigger the workflow engine, progressing the process to the next activity. For example, the ingestion workflow is one such case—once ingested, cataloguing should be performed.

### Backup

Regular backups should be maintained off-site in the event of a non-recoverable storage system failure. There are two types of backup:

Database (metadata and other);

Content.

Database and other system related backup occur in the regular manner (periodic full-backup and more frequent incremental backup). The database logs are mirrored at two sites so that there is no loss of committed transactions.

Content backup is managed differently. The most efficient time to backup new content on the system is at ingestion. As well as storing content in the content management system, a replica (with reference information, such as the unique asset identifier) is sent to a backup service. The backup service may be located at a third site separate to the two sites at which the base stations 1 are located. This provides increased disaster and recovery ability. However, if a third site is undesirable, the tape unit may be attached directly to the server at Site B.

The backup service has enough disk to cache all ingested content prior to backup and removal to tape. With a third site, a computer with disk and attached tape unit is required.

Backup tapes should be labeled with enough information to allow select content to be reloaded in the event of a failure. Such information may include ingestion date, customer details etc. Labels can be automatically generated from ingest information. In the event of a failure requiring system restoration, the reloading of content may be prioritized on the basis of collection, or other business sensitive criteria.

### Scalability

The base station 1 can be based on the NUMAflex architecture. Using standard, modular building blocks called bricks, the architecture scales independently in different dimensions over time, providing unprecedented levels of flexibility, resiliency, and investment protection.

Furthermore, storage can be scaled at the application level by configuring multiple Content Servers within the database management application. This means multiple storage arrays can be employed if required. There is no theoretical limit to the number, however, the more units there are, the more long-run fiber optic cable is required between sites.

### Security

All the processing systems 9, 10 are positioned behind a firewall. If hackers manage to breach the firewall they will need to bypass the standard IRIX security in order to access sensitive information.

Public facing services such as FTP and Web services are isolated from the core services implemented on the base station 1, such as the database and the database management application. This gives a further level of protection from penetration. Should a hacker penetrate the Web Server or FTP server, there are no other services on that system to be compromised.

The hacker would need to penetrate a second level of systems to reach core data, such as the content store.

### E-commerce

The API provides e-commerce shopping cart

The API provides 4-dimensional pricing matrix for licensing digital content instances based on 4 arbitrary degrees of freedom (example: usage, duration of license, audience, dimensions).

The API integrates e-commerce transaction server supporting payment via credit cards and trade credit accounts (debtors system).

### Implementation

Digital content instances can be added to an “order”, which can then be delivered according to a pre-defined fulfillment workflow.

The base station 1 supports the fulfillment of asset orders via an arbitrary delivery system, defined using the concept of a Service Provider. For example, a fulfillment module which delivers content instances to a set-top box could readily be created.

### Service Monitoring

A TCP/IP client may register interest in any base station service, and in any aspect of that service.

Monitoring messages are then transmitted to that client whenever the service is executed with the desired outcome (which may be “any” outcome).

Statistics may be associated with any service such that a counter is incremented each time a particular service executes with a desired outcome.

This is particularly useful not only in monitoring system performance and utilization, but also in integration of, for example, billing systems.

### Studio

Users may define an arbitrary number of Studios that are folders on the processing system for storing bookmarks or aliases to content instances.

Studios may be e-mailed to a distribution list of recipients.

Recipients may log in and leave comments in the Studio.

This is particularly useful for creative professionals in communicating amongst their workgroup and with their clients.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. A method of obtaining content from a remote store using an end station, the end station and the store being coupled to a processing system, the store storing a number of content instances and, content details, the content details providing predetermined information relating to each content instance, the method comprising the steps of:
a) Generating a content request using the end station;
b) Transferring the content request to the processing system;
c) Causing the processing system to select one or more content instances in accordance with the received content request;
d) Transferring the content details of the selected content instances to the end station;
e) Determining one or more of the content instances to be received;
f) Generating a content selection using the end station, the content selection indicating one or more of the selected content instances; and,
g) Transferring the content selection to the processing system;
h) Causing the processing system to transfer the content instances to the end station in accordance with the received selection request.

2. A method according to claim 1, the method of transferring the content instances to the end station in response to the received selection further comprising:
a) Determining a cost for providing the content;
b) Providing payment details in response to the determined cost;
c) Transferring the payment details from the end station to the processing system;
d) Causing the processing system to determine if the payment can be collected; and,
e) Transferring the content instances to the end station in response to a successful determination.

3. A method according to claim 2, the method of determining a cost further comprising:
a) Indicating the intended use of the content; and,
b) Determining the cost based on the intended use of the content.

4. A method according to claim 3, the method further comprising:
a) Transferring the indication of the intended use from the end station to the processing system; and,
b) Causing the processing system to:
i) Access cost data stored in the store; and,
ii) Determine a cost based on the cost data and the intended use of the content.

5. A method according claim 1, the method of transferring the content instances to the end station in response to the received selection further comprising:
a) Indicating the intended use of the content;
b) Transferring an indication of the intended use from the end station to the processing system;
c) Causing the processing system to generate a licensing agreement based on the intended use of the content;
d) Transferring the license to the end station;
e) Determining if the license is acceptable; and,
f) Transferring the content instances to the end station in response to a successful determination.

6. A method according to claim 1, wherein when the end station is coupled to the processing system via the Internet, the method of transferring the content to the end station includes transferring the content:
a) Using a FTP;
b) At a predetermined time; or
c) Via e-mail.

7. A method according to claim 1, the content request including one or more keywords, further comprising:
a) Causing the processing system to parse the keyword(s) to determine any:
i) Misspellings;
ii) Synonyms;
iii) Semantically non-unique keywords;
b) In response to a successful determination, causing the processing system to generate a query, the query requesting clarification of the respective keyword(s);
c) Providing a response to the query, the response including either:
i) A correctly spelled keyword; or
ii) Additional information to clarify the keyword so that the semantics or the synonym is uniquely identified;
d) Transferring the response to the processing system; and,
e) Causing the processing system to select content in accordance with the received response.

8. A method according to claim 1, the content request including one or more keywords, the content details including one or more keyword(s) associated with each content instance, the method of selecting content further comprising causing the processing system to:
a) Compare the received keyword(s) and the content data; and,
b) Select the content in accordance with the results of the comparison.

9. A method according to claim 1, the content request including one or more keywords, the content being classified using a hierarchical classification scheme, and the content details including one or more category designations representing the categories within which the content is classified, the method of selecting content further comprising causing the processing system to:
a) Compare the received keyword(s) to each category in the classification;
b) Select one or more categories in accordance with the results of the comparison; and,
c) Select the content from the one or more determined categories.

10. A method according to claim 1, the content request including one or more parameter values, the content details including one or more parameter values associated with each content instance, the method of selecting content further comprising causing the processing system to:
a) Compare the received parameter value(s) and the content data; and,
b) Select the content in accordance with the results of the comparison.

11. A method according to claim 10, the parameter value(s) including a threshold, the method further comprising causing the processing system to:
a) Compare each received parameter value to each parameter value associated with each content instance;
b) Determine the comparison to be successful if difference between the parameter values is less than the threshold;
c) Select the content associated with each parameter value for each successful comparison.

12. A method according to claim 1, the content including any of:
a) Images;
b) Video sequences; and,
c) Audio sequences.

13. A method according to claim 12, wherein when the content is an image or a video sequence, the corresponding content details include at least a proxy image, the proxy image being a low resolution version of the image or of one of the video sequence images, the proxy image being transferred to the end station as part of the content details.

14. A method according to claim 1, the content being encrypted in accordance with a predetermined encryption system, to thereby control the access of users to the data.

15. Apparatus for obtaining content from a remote store using an end station, the apparatus comprising a processing system adapted to:
a) Receive a content request from an end station;
b) Select one or more content instances in accordance with the received content request;
c) Transfer the content details of the selected content instances to the end station;
d) Receive an indication of one or more of the content instances to be received;
e) Transfer the content instances to the end station in accordance with the received selection request.

16. A computer program product comprising computer executable code that when executed by a suitably programmed processing system, causes the processing system to:
a) Receive a content request from an end station;
b) Select one or more content instances in accordance with the received content request;
c) Transfer the content details of the selected content instances to the end station;
d) Receive an indication of one or more of the content instances to be received;
e) Transfer the content instances to the end station in accordance with the received selection request.

17. A method of processing content for subsequent storage in a store, the method comprising:
a) Defining one or more keywords;
b) Causing a processing system to:
i) Receive content instance to be stored;
ii) Select one or more categories from a hierarchical classification scheme, in accordance with the selected keyword(s);
iii) Generate content details, including an indication of the selected categories; and,
iv) Store the content instance and the associated content details in the store.

18. A method according to claim 17, the method further comprising:
a) Causing the processing system to generate an indication of the selected categories; and,
b) Allowing a user modify the selected categories.

19. A method according to claim 17, the store being a database and the content details forming the meta-data associated with the respective content instance stored in the database.

20. A method according to claim 17, the method further comprising:
a) Causing the processing system to parse the received keyword(s) to determine any:
i) Misspellings;
ii) Synonyms;
iii) Semantically non-unique keywords;
b) In response to a successful determination, causing the processing system to generate a query, the query requesting clarification of the respective keyword(s);
c) Providing a response to the query, the response including either:
i) A correctly spelled keyword; or
ii) Additional information to clarify the keyword so that the semantics or the synonym is uniquely identified;
d) Transferring the response to the processing system.

21. A method according to claim 17, the method further comprising:
a) Defining a number of parameters; and,
b) Setting a parameter value for each content instance for selected ones of the parameters, the parameter value(s) being stored in the content details for each respective content instance, the parameter value being searchable to allow content to be located.

22. A method according to claim 21, the method further comprising defining a threshold for selected ones of the parameter value(s), the threshold indicating a range of values.

23. A method according to claim 17, the content including any of:
a) Images;
b) Video sequences; and,
c) Audio sequences.

24. A method according to claim 23, wherein when the content is an image or a video sequence, the corresponding content details including at least a proxy image, the proxy image being a low resolution version of the image or of one of the video sequence images.

25. A method according to claim 17, the content being encrypted in accordance with a predetermined encryption system, to thereby control the access of users to the data.

26. Apparatus for processing content for subsequent storage in a store, the apparatus comprising a processing system coupled to a store, the processing system including a processor adapted to:
a) Obtain the content to be stored;
b) Receive one or more keywords;
c) Select one or more categories from a hierarchical classification scheme, in accordance with the selected keywords;
d) Generate content details, including an indication of the selected categories; and,
e) Store the content instance and the associated content details in the store.

27. A computer program product comprising computer executable code that when executed by a suitably programmed processing system, causes the processing system to:
a) Obtain the content to be stored;
b) Receive one or more keywords;
c) Select one or more categories from a hierarchical classification scheme, in accordance with the selected keywords;
d) Generate content details, including an indication of the selected categories; and,
e) Store the content instance and the associated content details in the store.

28. Apparatus for providing content to an end station, the apparatus comprising:
a) A store for storing:
i) A number of content instances; and,
ii) Content details, the content details providing predetermined information relating to each content instance; and,
b) A processing system coupled to the end station, the processing system being adapted to:
i) Receive a request for content from the end station;
ii) Select one or more content instances in accordance with the received content request;
iii) Transfer the content details of the selected content instances to the end station;
iv) Receive a content selection from the end station, the content selection indicating one or more of the selected content instances; and,
v) Transferring the content instances to the end station in response to the received selection request.

29. Apparatus according to claim 27, wherein the processing system further comprises:
a) A first processing system coupled to the end station; and,
b) A second processing system coupled to the first processing system and the store.

30. Apparatus according to claim 29, wherein the first and second processing systems are coupled via a TCP/IP link.

31. Apparatus according to claim 29, wherein the first processing system is adapted to:
a) Receive the content request or content selection from the end station;
b) Generate one or more respective marked-up messages in accordance with the received content request or content selection;
c) Transfer the marked-up messages to the second processing system, the second processing system responding to the content request or content selection to provide content details or content instances; and,
d) Transfer the content details or content instances to the end station.

32. Apparatus according to claim 31, the marked-up messages being generated in accordance with an XML protocol.

33. Apparatus according to claim 29, the first and second processing system being positioned at different physical locations.

34. Apparatus according to claim 29, the content including any of:
a) Images;
b) Video sequences; and,
c) Audio sequences.

35. Apparatus according to claim 34, wherein when the content is an image or a video sequence, the corresponding content details including at least a proxy image, the proxy image being a low resolution version of the image or of one of the video sequence images.

36. Apparatus according to claim 27, the first processing system forming part of the end station.

37. Apparatus according to claim 27, the content being encrypted in accordance with a predetermined encryption system, to thereby control the access of users to the data.
